(19) United States
(12) Patent Application Publication
(10) Pub. No.: US 2018/0075795 A1
(43) Pub. Date: Mar. 15, 2018

(54) CONTROL METHOD

(71) Applicant: AU OPTRONICS CORPORATION, Hsin-chu (TW)

(72) Inventor: Hui-Feng LIN, Hsin-chu (TW)

(21) Appl. No.: 15/480,875

(22) Filed: Apr. 6, 2017

(30) Foreign Application Priority Data
Sep. 12, 2016 (TW) 105129643

(51) Int. Cl. G09G 3/20; G09G 3/34; G09G 3/36

(52) U.S. Cl. CPC G09G 3/2011; G09G 3/2003; G09G 3/3413; G09G 2320/0673; G09G 2330/023; G09G 2320/066; G09G 2320/0626; G09G 3/36

(57) ABSTRACT

A control method for a display includes a general mode and a electricity-saving mode. In the general mode, according to a plurality of first gray scale values corresponding respectively to a plurality of first origin colors, obtaining a second gray scale value corresponding to a second origin color other than the first origin colors. According to the first and second gray scale values, producing a plurality of third gray scale values defined into a plurality of first origin color gray scale values corresponding to the first origin colors respectively, and a second origin color gray scale value corresponding to the second origin color. Adjusting the third gray scale values according to a contrast enhancement function. Obtaining a plurality of driving gray scale values according to the adjusted third gray scale values. Driving the display to provide an image according to driving gray scale values.

### CROSS-REFERENCE TO RELATED PATENT APPLICATION

This application claims the benefit of priority to Taiwan Patent Application No. 105129643, filed Sep. 12, 2016. The entire content of the above identified application is incorporated herein by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD

The present disclosure relates to a control method, and in particular, to a control method for controlling multi-primary color gray-scale data.

### BACKGROUND

With the progress of science and technology, liquid crystal displays have been widely applied to various mobile information display devices, for example, mobile phone, and tablet computers. In electronic products of this type, battery cruising capability thereof has been always one of problems that consumers pay most attention to. In addition to a network or GPS positioning, a liquid crystal display occupies a high ratio of power consumption therein. However, specifications of current liquid crystal displays continuously pursue wide color gamut, high brightness, and ultrahigh resolution, and therefore a backlight module with special specification in cooperation with a complicated graphics processing unit (GPU) may be needed.

However, the changes in the specification may increase power consumption of a liquid crystal panel. In a case a battery level does not change, use time of an electronic apparatus is shortened. By using a mobile phone as an example, in existing products, power consumption is habitually reduced by manually adjusting backlight brightness or enabling a power saving mode. However, if in outdoor strong light, when brightness of backlight cannot be adjusted higher due to limited power and information displayed on a screen cannot be clearly seen, use experience of a user is significantly affected.

### SUMMARY

The present disclosure lies in providing a control method, so as to enable a user to freely use a mobile information display device in various cases.

The control method disclosed by the present disclosure is applicable to a display, where the control method includes receiving a plurality of input image data; and determining to operate in a general mode or a power saving mode according to the input image data. According to the control method, a second gray-scale data is obtained according to a plurality of first gray-scale data in the power saving mode. The plurality of first gray-scale data corresponds to a plurality of first primary colors respectively, and the second gray-scale data corresponds to a second primary color other than the first primary colors. A plurality of third gray-scale data is generated according to the plurality of first gray-scale data and the second gray-scale data. The plurality of third gray-scale data defines a plurality of first primary color gray-scale data and a second primary color gray-scale data. The plurality of first primary color gray-scale data corresponds to the first primary colors respectively. The second primary color gray-scale data corresponds to the second primary color. In addition, the third gray-scale data is adjusted according to a contrast enhancement function. Then, a plurality of driving gray-scale voltages is found, by means of look-up, according to the adjusted third gray-scale data, and the display is driven according to the driving gray-scale voltages to provide an image.

In an embodiment, the control method provided by the present disclosure further comprises: quantizing the input image data to form the first gray-scale data, where the plurality of input image data is represented by using M bits; the plurality of first gray-scale data is represented by using N bits; M and N are positive integers, and M is greater than N.

In another embodiment, in the step of obtaining the second gray-scale data according to the first gray-scale data, further including: determining a maximum value of the plurality of first gray-scale data; and using the maximum value as a value of the second gray-scale data. In the step of generating the plurality of third gray-scale data according to the plurality of first gray-scale data and the second gray-scale data, the plurality of first gray-scale data is used as the plurality of first primary color gray-scale data in the plurality of third gray-scale data.

In a further embodiment, in the step of obtaining the second gray-scale data according to the first gray-scale data, further including: determining a maximum value of the plurality of first gray-scale data; and using the maximum value as a value of the second gray-scale data. However, in the step of obtaining the second gray-scale data according to the first gray-scale data, further including: determining whether the plurality of first gray-scale data is used to indicate a pure color. When it is determined that the plurality of first gray-scale data is not used to indicate a pure color, a minimum value in the plurality of first gray-scale data is determined. In addition, the plurality of first primary color gray-scale data in the plurality of third gray-scale data is generated according to the minimum value and the maximum value. However, in the step of generating the plurality of first primary color gray-scale data in the plurality of third gray-scale data according to the minimum value and the maximum value, an operated value is obtained according to the minimum value and the maximum value; and the operated value is used as the plurality of first primary color gray-scale data in the plurality of third gray-scale data. The operated value is a value obtained by dividing a sum of the maximum value and the minimum value by an operation coefficient; and the operation coefficient is not less than 1 and not greater than 2.

In a further embodiment, when one of the plurality of third gray-scale data is greater than a reference value, the third gray-scale data greater than the reference value is enlarged according to the contrast enhancement function. When one of the plurality of third gray-scale data is less than the reference value, the third gray-scale data less than the reference value is reduced according to the contrast enhancement function. The reference value is not less than gray-scale data 128, and is not greater than gray-scale data 186.

Based on the above, the present disclosure provides a control method, including: in addition to generating third gray-scale data according to first gray-scale data and second gray-scale data, further adjusting the third gray-scale data according to a contrast enhancement function, and then finding, by means of look-up, driving gray-scale voltages according to the adjusted third gray-scale data to drive a display to provide a suitable image. In a case in which the control method provided by the present disclosure is applied, power consumption of operation associated with gray-scale data can be reduced, and in cooperation with an architecture design of the foregoing novel backlight module, power saving efficiency can be effectively improved, and screen information under strong light can be identified.

The foregoing description of content of the present disclosure and the following description of implementation manners are used to exemplify and explain the spirit and principles of the present disclosure, and provide further understanding of the patent application scope of the present disclosure.

### BRIEF DESCRIPTION OF THE DRAWINGS

The disclosure will become more fully understood from the detailed description given herein below for illustration only, and thus are not limitative of the disclosure, and wherein:

FIG. 1 is a step flowchart of a control method according to an embodiment of the present disclosure.

FIG. 2 is a step flowchart of a control method according to another embodiment of the present disclosure.

FIG. 3 is a detailed step flowchart of a general mode of a control method according to FIG. 2.

FIG. 4 is a detailed step flowchart of a power saving mode of a control method according to FIG. 2.

FIG. 5 is a detailed step flowchart of one step therein of a power saving mode according to FIG. 4.

FIG. 6 is a graph of a contrast enhancement function according to an embodiment of the present disclosure.

FIG. 7 is a schematic layout diagram of a backlight module according to an embodiment of the present disclosure.

FIG. 8 is a schematic layout diagram of a backlight module according to another embodiment of the present disclosure.

FIG. 9 is a schematic layout diagram of a backlight module according to a further embodiment of the present disclosure.

FIG. 10 is a schematic diagram of a light emitting encapsulation unit according to FIG. 9 of the present disclosure.

### DETAILED DESCRIPTION

Detailed features and advantages of the present disclosure are described in detail below in implementation manners, and content thereof can sufficiently enable any person skilled in the art to learn technical content of the present disclosure and implement the present disclosure according to the technical content of the present disclosure, and according to content disclosed in the present description, the claims, and accompanying drawings, any person skilled in the art can easily understand relevant objectives and advantages of the present disclosure. The following embodiments further describe viewpoints of the present disclosure in detail, but are not intended to limit the scope of the present disclosure by using any viewpoint.

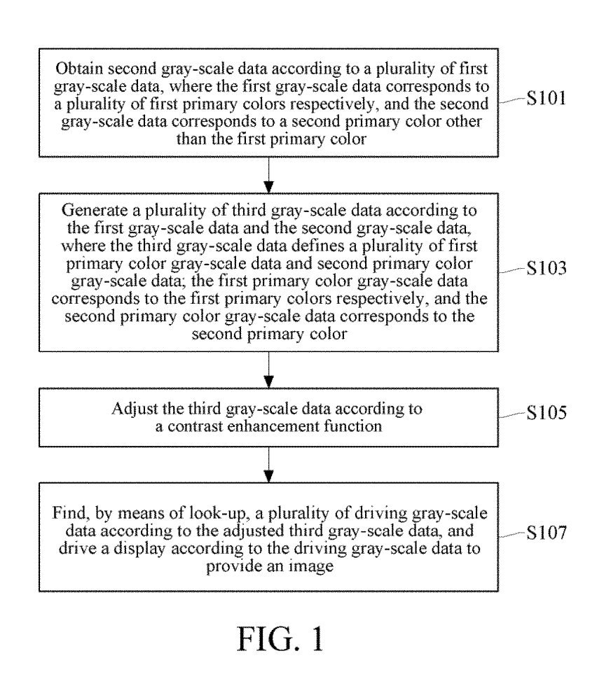

With reference to FIG. 1, FIG. 1 is a step flowchart of a control method according to an embodiment of the present disclosure. FIG. 1 discloses a control method applicable to a display. The control method includes receiving an input image data and determining to operate in a general mode or a power saving mode according to the input image data. In an embodiment, a general mode or a power saving mode is switched according to a manually generated control signal; or in another embodiment, according to an external environment, a control signal automatically generated by a system switches a general mode or a power saving mode. However, the present disclosure is not limited thereto. In the power saving mode, the control method has a plurality of steps shown in FIG. 1. As shown in FIG. 1, in step S101, second gray-scale data is first obtained according to a plurality of first gray-scale data. The plurality of first gray-scale data corresponds to a plurality of first primary colors respectively, and the second gray-scale data corresponds to a second primary color other than the first primary colors. However, in step S103, a plurality of third gray-scale data is generated according to the plurality of first gray-scale data and the second gray-scale data. The plurality of third gray-scale data defines a plurality of first primary color gray-scale data and second primary color gray-scale data. The plurality of first primary color gray-scale data corresponds to the first primary colors respectively. The second primary color gray-scale data corresponds to the second primary color. In step S105, the third gray-scale data is adjusted according to a contrast enhancement function. Then, in step S107, a plurality of driving gray-scale data is found, by means of look-up, according to the adjusted third gray-scale data, and the display is driven according to the driving gray-scale data to provide an image.

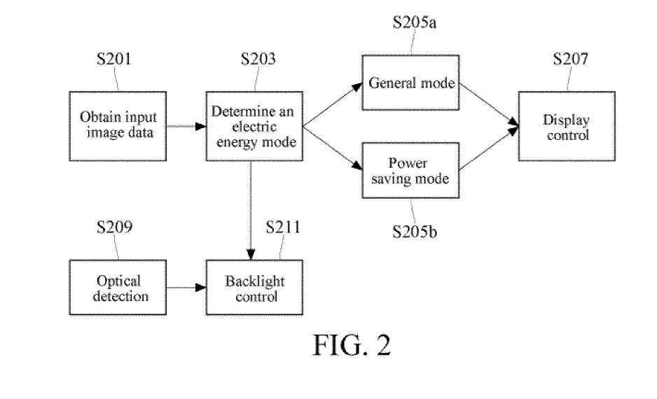

Next, with reference to FIG. 2, FIG. 2 describes, on a system level, the control method provided by the present disclosure. FIG. 2 is a step flowchart of a control method according to another embodiment of the present disclosure. For narration conciseness, main content is marked only in a box corresponding to each step in FIG. 2 and subsequent step flowcharts, and detailed content is described in detail in the description. A person of ordinary skill can unambiguously understand relevant content according to content of drawings in cooperation with the description.

As shown in FIG. 2, in step S201, input image data is first obtained, and an electric energy mode is determined in step S203. Step S201 and step S203 have no particular sequence, and are merely exemplified herein, and the present disclosure is not limited to the sequence. After step S203, step S205a or step S205b is selectively entered. Step S205a is a general mode, and step S205b is power saving mode. Then display control is performed in step S207 after step S205a and step S205b. On the other aspect, optical control is performed in step S209, and in step S211, backlight control is performed according to a determining result of step S203 and a detection result in step S209.

In an embodiment, the input image data, for example, is three primary color gray-scale data for representing red, green, and blue (RGB). In this and subsequent embodiments, subsequent description is made by using the input image data as the three primary color gray-scale data for representing red, green, and blue. However, in practice, a person of ordinary skill in the art may select other gray-scale data defining manners after reading the present description in detail, and limitation is not performed herein.

In an embodiment, in step S203, determining is performed, for example, according to remaining power of a system, status of various current operating programs, or an input instruction of a user, so as to determine whether to enter a general mode or a power saving mode.

Description is made in detail for relevant content of step S205a and step S205b. In step S207, a display is controlled according to a relevant result in the general mode or the power saving mode, so as to provide a suitable display image.

However, optical detection in step S209 is to, for example, detect a current ambient brightness or a current ambient color temperature, so as to determine whether the display image provided by the display is watched by a user in a case of excessive brightness or in a case in which a color cast easily occurs.

In step S211, backlight control is controlled according to whether the system is currently in the general mode or the power saving mode with the assistance of a result of the optical detection. The step is subsequently described in detail with relevant drawings.

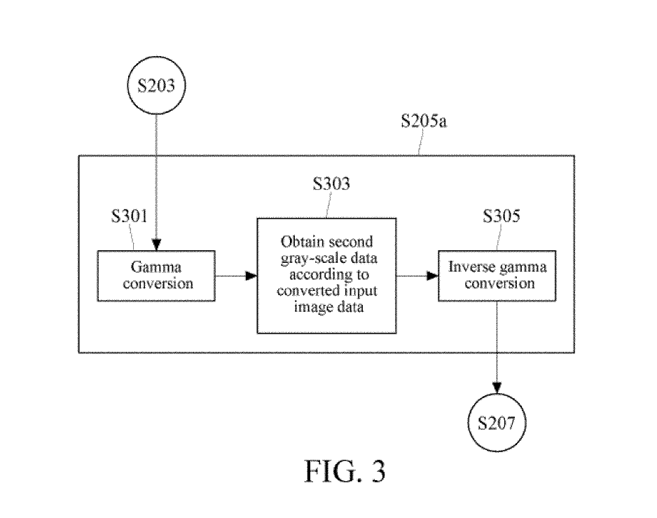

Next, with reference to FIG. 3, FIG. 3 describes the foregoing general mode in detail. FIG. 3 is a detailed step flowchart of the general mode of the control method according to FIG. 2. As shown in FIG. 3, steps S301, S303, and S305 are further performed in sequence in step S205a. In step S301, gamma conversion is performed on the input image data. Then in step S303, third gray-scale data is obtained according to the converted input image data. As stated above, the plurality of third gray-scale data defines a plurality of first primary color gray-scale data and at least one second primary color gray-scale data. The plurality of first primary color gray-scale data respectively corresponds to colors represented by the first gray-scale data, and the second primary color gray-scale data corresponds to colors represented by the second gray-scale data.

In an embodiment, the first gray-scale data respectively corresponds to red, green, and blue, and the second gray-scale data corresponds to white. Accordingly, in this embodiment, the plurality of third gray-scale data defines a plurality of the first primary color gray-scale data and the second primary color gray-scale data. The first primary color gray-scale data respectively corresponds to red, green, and blue, and the second primary color gray-scale data corresponds to white. In this and subsequent embodiments, description is made by using that the third gray-scale data is multi-primary color gray-scale data that represents red, green, blue, and white as an example. However, in practice, a person of ordinary skill in the art may select other gray-scale data defining manners after reading the present description in detail, and limitation is not performed herein.

Then in step S305, inverse gamma conversion is performed on the third gray-scale data to obtain driving gray-scale data. Subsequently, in step S307, the display is driven according to the driving gray-scale data, to provide a suitable display image. Relevant content of the foregoing gamma conversion, conversion between RGB and RGBW, and inverse gamma conversion that are mentioned in step S301, step S303, and step S305 can be freely designed by a person of ordinary skill in the art after the person reads the present description in detail, and limitation is not performed herein.

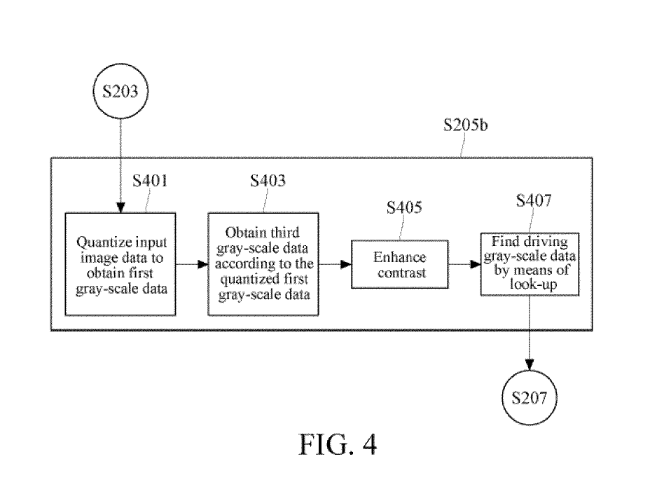

Next, with reference to FIG. 4, FIG. 4 describes the foregoing power saving mode in detail. FIG. 4 is a detailed step flowchart of the power saving mode of the control method according to FIG. 2. As shown in FIG. 4, steps S401, S403, S405, and S407 are further performed in sequence in step S205b.

In step S401, the plurality of input image data is first quantized to obtain the plurality of first gray-scale data. From another aspect, the plurality of input image data is represented by using M bits; the plurality of first gray-scale data is represented by using N bits; M and N are positive integers, and M is greater than N. In an embodiment, for example, M is 8, and N is 6. However, the present disclosure is not limited thereto. In practice, the foregoing quantization process, for example, is to delete at least one least significant bit (LSB) in the M bits of each piece of the first gray-scale data, or to increase or decrease a remaining residual value according to at least one least significant bit.

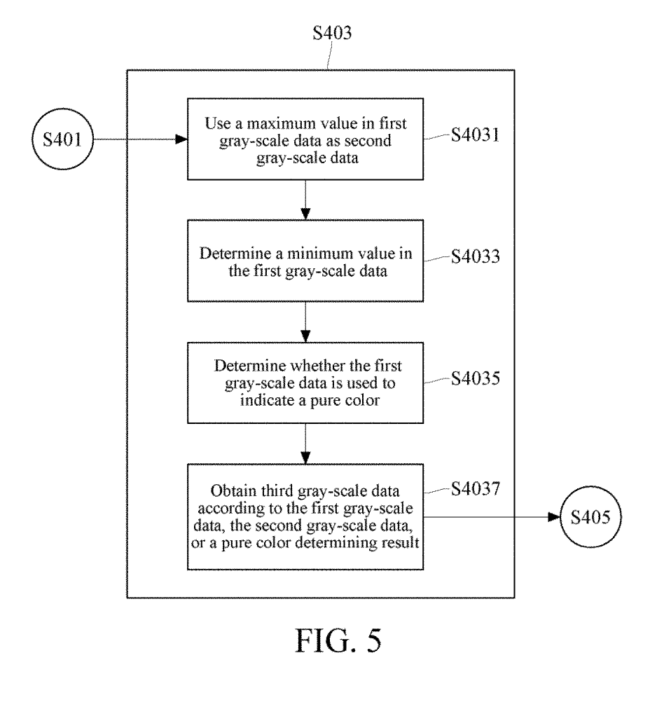

In step S403, the third gray-scale data is obtained according to the quantized first gray-scale data. With reference to FIG. 5 together, FIG. 5 describes the step in a more detailed way. FIG. 5 is a detailed step flowchart of one step therein of the power saving mode according to FIG. 4. As shown in FIG. 5, step S4031 to step S4037 are further performed in sequence in step S403. In step S4031, a maximum value in the first gray-scale data is determined, and the maximum value is used as the second gray-scale data. In step S4033, a minimum value in the plurality of first gray-scale data is determined for use in subsequent operation. In step S4035, whether the plurality of first gray-scale data is used to indicate a pure color is determined. In an embodiment, when at least one of the plurality of first gray-scale data is 0, it is determined that the plurality of first gray-scale data is used to indicate a pure color. However, in another embodiment, when at least one of the plurality of first gray-scale data is less than a preset threshold, it is determined that the plurality of first gray-scale data is used to indicate a pure color. The preset threshold, for example, is a threshold defined by a user. In other words, in a case in which the first gray-scale data is the three primary color gray-scale data for representing red, green, and blue, a definition of the pure color may be one of red, green, and blue, a mixed color of two of red, green, and blue, or a mixed color of two of red, green, and blue and a trace of another color. In practice, steps S4031, S4033, and S4035 have no particular relative sequence. However, steps S4033 and S4035 are selective designs, and do not necessarily exist in step S403.

In step S4037, the third gray-scale data is obtained according to the first gray-scale data, the second gray-scale data, or the foregoing pure color determining result. In an embodiment, the plurality of first gray-scale data is used as the plurality of first primary color gray-scale data in the plurality of third gray-scale data, and the second gray-scale data is used as the second primary color gray-scale data in the third gray-scale data. Pure color determining is further performed in another embodiment. When it is determined that the plurality of first gray-scale data is used to indicate a pure color, the plurality of first gray-scale data is used as the plurality of first primary color gray-scale data in the third gray-scale data. However, when it is determined that the plurality of first gray-scale data is not used to indicate a pure color, a minimum value in the plurality of first gray-scale data is determined, and the first primary color gray-scale data in the third gray-scale data is generated according to the minimum value and a maximum value in the first gray-scale data.

In practice, in the step of generating the first primary color gray-scale data in the third gray-scale data according to the minimum value and the maximum value, an operated value is obtained according to the minimum value and the maximum value; and the operated value is used as the first primary color gray-scale data in the third gray-scale data. The operated value is a value obtained by dividing a sum of the maximum value and the minimum value by an operation coefficient; and the operation coefficient is not less than 1 and not greater than 2. By using RGB as an example, the operated value may be expressed in the following formulas:

$$\begin{matrix}{R}_{o} = \frac{( {[ RGB ]}_{MAX} + {[ RGB ]}_{min} )}{k} , 1 \leq k \leq 2 \\ {G}_{o} = {R}_{o} \\ {B}_{o} = {R}_{o}\end{matrix}$$

In the foregoing formulas, [RGB]_{MAX} is the maximum value in the first gray-scale data; [RGB]ₘᵢₙ is the minimum value in the plurality of first gray-scale data; R₀, B₀, and G₀are the first primary color gray-scale data in the third gray-scale data; k is the operation coefficient.

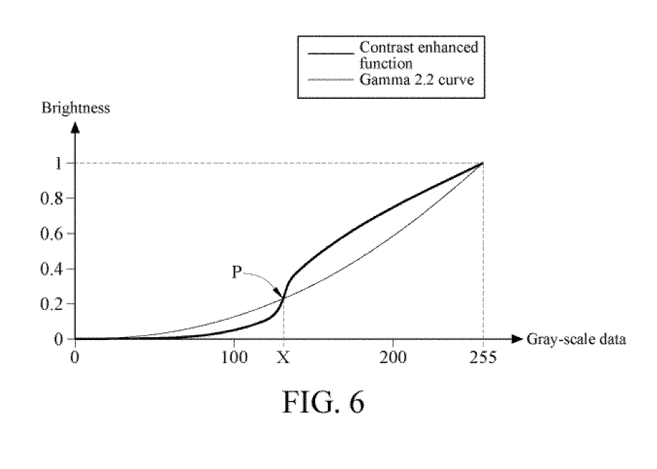

With reference to FIG. 4 again, in step S405, the third gray-scale data obtained in step S403 is adjusted according to a contrast enhancement function to enhance a contrast degree of the third gray-scale data. With reference to FIG. 6 together, FIG. 6 is a graph of a contrast enhancement function according to an embodiment of the present disclosure. In FIG. 6, the horizontal axis represents gray-scale data, and the longitudinal axis represents brightness values respectively corresponding to gray-scale data. In an embodiment, the gray-scale data is gray-scale values 0 to 255; the brightness values are values standardized according to brightness values corresponding to gray-scale value 255. In the embodiment shown in FIG. 6, a contrast enhancement function is an S-shaped function, and is used as basis for enlarging or improving a part of gray-scale data, and is used as basis for decreasing or reducing the other part of the gray-scale data. In an embodiment, the contrast enhancement function, for example, may be expressed as

$${( \frac{g}{255} )}^{2.2} .$$

However, the present disclosure is not limited thereto. g is a gray-scale value, 0≦g≦255.

More specifically, the contrast enhancement function has a turning point P, which corresponds to a reference value x on the horizontal axis of FIG. 6. In this embodiment, the turning point P of the contrast enhancement function is a point of intersection between the contrast enhancement function and a gamma 2.2 curve. When one of a plurality of third gray-scale data is greater than the reference value x, a brightness value obtained according to the contrast enhancement function is greater than a brightness value obtained by using the gamma 2.2 curve. However, when one the plurality of third gray-scale data is less than the reference value x, the brightness value obtained according to the contrast enhancement function is less than the brightness value obtained by using the gamma 2.2 curve. Therefore, compared with the gamma 2.2 curve, adjustment made on the third gray-scale data according to the contrast enhancement function further enlarges differences between gray-scale data and the reference value that is greater than or less than the gray-scale data, and a contrast degree of a subsequent image is enhanced. The reference value x is not greater than gray-scale value 186, and not less than gray-scale value 128.

For a more specific example, the reference value x is made gray-scale data 150. Compared with the gamma 2.2 curve, pieces of the third gray-scale data greater than gray-scale data 150 are enlarged according to the contrast enhancement function, and pieces of the third gray-scale data less than the gray-scale data 150 are reduced according to the contrast enhancement function. When the third gray-scale data is equal to the gray-scale data 150, a size of the third gray-scale data may be reduced, improved or maintained relative to the gamma 2.2 curve according to actual requirements. In an embodiment, the foregoing enlargement or reduction is relative to the gamma 2.2 curve.

The reference value x is not less than the gray-scale data 128, and is not greater than the gray-scale data 186. In an embodiment, a part, where the gray-scale data is greater than the reference value x, of the contrast enhancement function is concave downward, and a part, where the gray-scale data is less than the reference value x, of the contrast enhancement function is concave upward.

In step S407, driving gray-scale data is found, by means of look-up, according to the third gray-scale data after enhanced contrast is performed on the third gray-scale data, so as to drive a display according to the driving gray-scale data to provide a suitable display image in step S207. The look-up manner may be: finding, by means of look-up, the corresponding driving gray-scale data by using a look up table (LUT) according to the third gray-scale data after enhanced contrast is performed on the third gray-scale data. In an embodiment, a plurality of driving gray-scale data may be found by means of look-up by using a look up table according to the third gray-scale data after enhanced contrast is performed on the third gray-scale data, and interpolation, extrapolation, or other operation is performed according to the found plurality of driving gray-scale data, to obtain the driving gray-scale data. The driving gray-scale data is obtained by using a look up table, so that a laborious operation process in the past can be omitted, thereby saving operation power consumption and circuit costs.

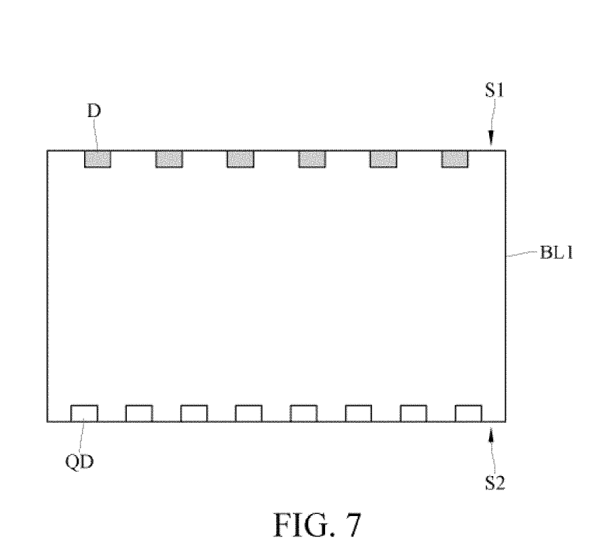

Next, with reference to FIG. 7, FIG. 7 describes how to perform backlight control in the foregoing step S211. FIG. 7 is a schematic layout diagram of a backlight module according to an embodiment of the present disclosure. A backlight module BL1 is provided in the foregoing display. As shown in FIG. 7, the backlight module BL1 defines a first side S1 and a second side S2, where the first side S1 and the second side S2 are two opposite sides. In an embodiment, the first side S1 is an upper side in actual use of the display, and the second side S2 is a lower side in actual use of the display. A plurality of first light emitting diodes D is provided on the first side S1, and a plurality of second light emitting diodes QD is provided on the second side S2. A light emitting color gamut range of the second light emitting diodes QD is greater than that of the first light emitting diodes D. In an embodiment, the second light emitting diode QD, for example, is a quantum dot light emitting diode. However, the present disclosure is not limited thereto.

In the embodiment of FIG. 7, when it is determined that a general mode is used in the foregoing step S203, each of the second light emitting diodes QD is controlled to emit light. However, when it is determined that a power saving mode is used in the foregoing step S203, each of the first light emitting diodes D is controlled to emit light. In this way, not only operation power consumption is reduced in step S205b, but also power consumption of the backlight module BL1 when the power saving mode is entered is reduced.

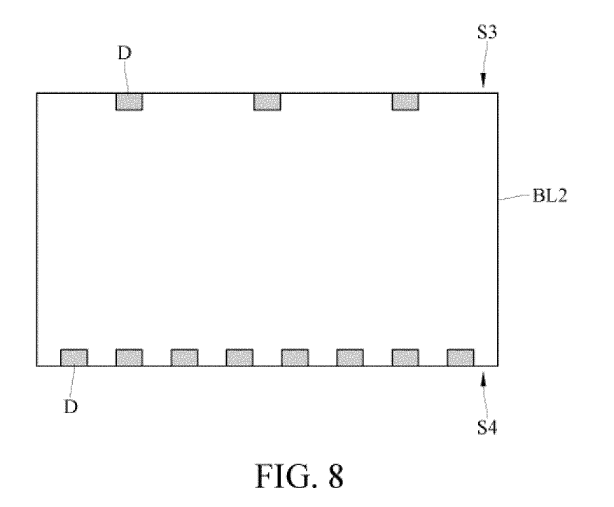

Next, with reference to FIG. 8, FIG. 8 is a schematic layout diagram of a backlight module according to another embodiment of the present disclosure. A backlight module BL2 defines a first side S3 and a second side S4, where the first side S3 and the second side S4 are two opposite sides. In an embodiment, the first side S3 is an upper side in actual use of a display, and the second side S4 is a lower side in actual use of the display. The lower side faces a bearing surface set on the display, and the upper side is the other side opposite to the lower side. Y first light emitting diodes D are provided on the first side S3, and Z first light emitting diodes D are provided on the second side S4. Y and Z are positive integers, and Z is greater than Y.

In the embodiment of FIG. 8, when it is determined that a general mode is used in the foregoing step S203, each of the first light emitting diodes D on the first side S3 and each of the first light emitting diodes D on the second side S4 are controlled to emit light. However, when it is determined that a power saving mode is used in the foregoing step S203, the first light emitting diodes D on the first side S3 are controlled not to emit light, and the first light emitting diodes D on the second side S4 are controlled to emit light. In this way, not only operation power consumption is reduced in step S205b, but also power consumption of the backlight module BL2 when the power saving mode is entered is reduced.

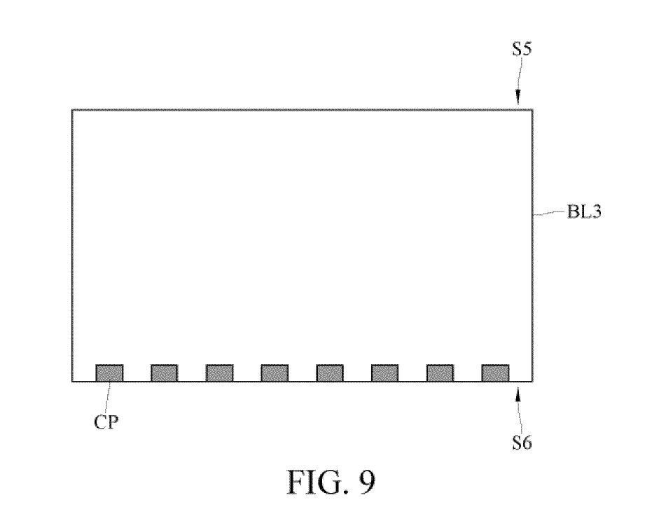

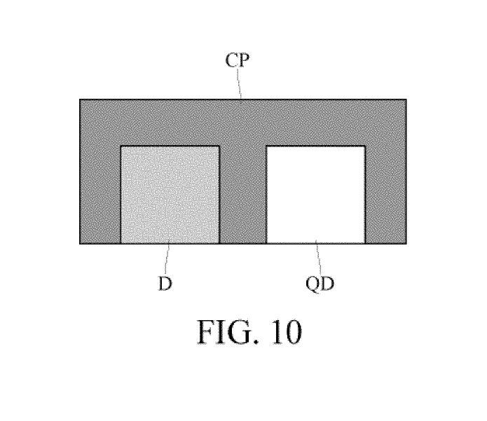

Next, with reference to FIG. 9 and FIG. 10, FIG. 9 is a schematic layout diagram of a backlight module according to a further embodiment of the present disclosure, and FIG. 10 is a schematic diagram of a light emitting encapsulation unit according to FIG. 9 of the present disclosure. A backlight module BL3 defines a first side S5 and a second side S6, where the first side S5 and the second side S6 are two opposite sides. In an embodiment, the first side S5 is an upper side in actual use of a display, and the second side S6 is a lower side in actual use of the display. In the embodiment corresponding to FIG. 9, a plurality of light emitting encapsulation units CPs are provided on the second side S6. However, as shown in FIG. 10, each of the light emitting encapsulation units CPs has a first light emitting diode D (not drawn in FIG. 9) as stated above, and a second light emitting diode QD (not drawn in FIG. 9) as stated above. A light emitting color gamut range of the second light emitting diode QD is greater than that of the first light emitting diode D. When it is determined that a general mode is used in the foregoing step S203, the second light emitting diode QD is controlled to emit light, and the first light emitting diode D is controlled not to emit light. When it is determined that a power saving mode is used in the foregoing step S203, the second light emitting diode QD is controlled not to emit light, and the first light emitting diode D is controlled to emit light.

Based on the above, the present disclosure provides a control method, including: in addition to generating third gray-scale data according to first gray-scale data and second gray-scale data, further adjusting the third gray-scale data according to a contrast enhancement function, and then finding, by means of look-up, driving gray-scale voltages according to the adjusted third gray-scale data to drive a display to provide a suitable image. However, for application of the control method provided by the present disclosure relative to an RGBW liquid crystal display, when a conventional RGBW liquid crystal display displays a pure-color image, because an RGB pixel area is less than that of an RGB liquid crystal display, pure-color brightness is reduced, and brightness of a white image is excessive, and consequently, image quality of the RGBW liquid crystal display is worse than that of a general RGB liquid crystal display. In general use state, to ensure image quality that can match a conventional RGB panel, complicated signal conversion is needed, leading to more power consumption of a signal processor. In a case in which the control method provided by the present disclosure is applied, and in cooperation with an architecture design of the foregoing novel backlight module, power saving efficiency can be effectively improved, and screen information under strong light can be identified.

The present disclosure is disclosed through the foregoing embodiments; however, these embodiments are not intended to limit the present disclosure. Various changes and modifications without departing from the spirit and scope of the present disclosure shall fall within the protection scope of the present disclosure. The protection scope of the present disclosure is subject to the appended claims.

What is claimed is:

1. A control method, applicable to a display, wherein the control method comprises:
receiving a plurality of input image data; and
determining to operate in a general mode or a power saving mode according to the plurality of input image data, wherein
the power saving mode comprises:
obtaining a second gray-scale data according to a plurality of first gray-scale data, wherein the plurality of first gray-scale data corresponds to a plurality of first primary colors respectively, and the second gray-scale data corresponds to a second primary color other than the first primary colors;
generating a plurality of third gray-scale data according to the plurality of first gray-scale data and the second gray-scale data, wherein the plurality of third gray-scale data defines a plurality of first primary color gray-scale data and a second primary color gray-scale data; the plurality of first primary color gray-scale data corresponds to the first primary colors respectively, and the second primary color gray-scale data corresponds to the second primary color;
adjusting the plurality of third gray-scale data according to a contrast enhancement function; and
finding, by means of look-up, a plurality of driving gray-scale voltages according to the adjusted third gray-scale data, and driving, according to the driving gray-scale voltages, the display to provide an image.

2. The control method according to claim 1, further comprising:
quantizing the plurality of input image data to form the plurality of first gray-scale data, wherein the plurality of input image data is represented by using M bits; the plurality of first gray-scale data is represented by using N bits; M and N are positive integers, and M is greater than N.

3. The control method according to claim 1, wherein in the step of obtaining the second gray-scale data according to the plurality of first gray-scale data, further comprising:
determining a maximum value of the plurality of first gray-scale data; and
using the maximum value as a value of the second gray-scale data.

4. The control method according to claim 3, wherein in the step of generating the plurality of third gray-scale data according to the plurality of first gray-scale data and the second gray-scale data, the plurality of first gray-scale data is used as the plurality of first primary color gray-scale data in the plurality of third gray-scale data.

5. The control method according to claim 3, wherein in the step of obtaining the second gray-scale data according to the plurality of first gray-scale data, further comprising:
determining whether the plurality of first gray-scale data is used to indicate a pure color;
when it is determined that the plurality of first gray-scale data is not used to indicate a pure color, determining a minimum value in the plurality of first gray-scale data; and
generating the plurality of first primary color gray-scale data in the plurality of third gray-scale data according to the minimum value and the maximum value.

6. The control method according to claim 5, wherein in the step of generating the plurality of first primary color gray-scale data in the plurality of third gray-scale data according to the minimum value and the maximum value, an operated value is obtained according to the minimum value and the maximum value; and the operated value is used as the plurality of first primary color gray-scale data in the plurality of third gray-scale data, wherein the operated value is a value obtained by dividing a sum of the maximum value and the minimum value by an operation coefficient; and the operation coefficient is not less than 1 and not greater than 2.

7. The control method according to claim 6, wherein when at least one of the plurality of first gray-scale data is 0, the plurality of first gray-scale data is determined to indicate the pure color.

8. The control method according to claim 5, wherein when the plurality of first gray-scale data is determined to indicate the pure color, the plurality of first gray-scale data is used as the plurality of first primary color gray-scale data in the plurality of third gray-scale data.

9. The control method according to claim 8, wherein when at least one of the plurality of first gray-scale data is 0, the plurality of first gray-scale data is determined to indicate the pure color.

10. The control method according to claim 1, wherein when one of the plurality of third gray-scale data is greater than a reference value, the third gray-scale data greater than the reference value is enlarged according to the contrast enhancement function; when one of the plurality of third gray-scale data is less than the reference value, the third gray-scale data less than the reference value is reduced according to the contrast enhancement function.

11. The control method according to claim 10, wherein the reference value is not less than gray-scale data 128, and is not greater than gray-scale data 186.

12. The control method according to claim 1, wherein the display has a backlight module; a plurality of first light emitting diodes is provided on one side of the backlight module; a plurality of second light emitting diodes is provided on the other side of the backlight module; a light emitting color gamut range of the second light emitting diodes is greater than that of the first light emitting diodes, and the control method comprises:
in the general mode, controlling the second light emitting diodes to emit light; and
in the power saving mode, controlling the first light emitting diodes to emit light.

13. The control method according to claim 1, wherein the display has a backlight module; a plurality of first light emitting diodes is separately provided on a first side and a second side of the backlight module; a quantity of the first light emitting diodes on the first side is greater than a quantity of the first light emitting diodes on the second side; the control method comprises:
in the power saving mode, controlling the first light emitting diodes on the first side not to emit light, and controlling the first light emitting diodes on the second side to emit light.

14. The control method according to claim 1, wherein the display has a backlight module; a plurality of light emitting units is provided on one side of the backlight module; each of the light emitting units has a first light emitting diode and a second light emitting diode; a light emitting color gamut range of the second light emitting diode is greater than that of the first light emitting diode, and the control method comprises:
in the general mode, controlling second light emitting diodes to emit light and controlling first light emitting diodes not to emit light; and
in the power saving mode, controlling the second light emitting diodes not to emit light and controlling the first light emitting diodes to emit light.
